(19) United States
(12) Patent Application Publication
(10) Pub. No.: US 2024/0202581 A1
(43) Pub. Date: Jun. 20, 2024

(54) CONFIGURING ARTIFICIAL INTELLIGENCE-BASED VIRTUAL ASSISTANTS USING RESPONSE MODES

(71) Applicant: International Business Machines Corporation, Armonk, NY (US)

(72) Inventors: Matthew Richard Arnold, Yorktown Heights, NY (US); Eric Donald Wayne, Durham, NC (US); Saloni Potdar, Jersey City, NJ (US)

(21) Appl. No.: 18/085,257

(22) Filed: Dec. 20, 2022

(51) Int. Cl. G06N 20/00

(52) U.S. Cl. CPC G06N 20/00

(57) ABSTRACT

Methods, systems, and computer program products for configuring artificial intelligence-based virtual assistants using response modes are provided herein. A computer-implemented method includes configuring multiple response modes in connection with at least one artificial intelligence-based virtual assistant, each response mode corresponding to a respective set of operational settings for the at least one artificial intelligence-based virtual assistant; implementing, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant; and configuring at least one workflow to be carried out by the at least one artificial intelligence-based virtual assistant in response to the at least one user request and in accordance with the implemented response mode.

### BACKGROUND

The present application generally relates to information technology and, more particularly, to language processing techniques. More specifically, virtual assistants commonly process language inputs in an attempt to recognize and/or respond to user requests. However, conventional virtual assistant approaches commonly lack accuracy and/or clarity, often resulting in errors and poor user experiences and/or adoption.

### SUMMARY

In at least one embodiment, techniques for configuring artificial intelligence-based virtual assistants using response modes are provided.

An example computer-implemented method can include configuring multiple response modes in connection with at least one artificial intelligence-based virtual assistant, each response mode corresponding to a respective set of one or more operational settings for the at least one artificial intelligence-based virtual assistant. The method can also include implementing, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant. Further, the method can additionally include configuring at least one workflow to be carried out by the at least one artificial intelligence-based virtual assistant in response to the at least one user request and in accordance with the implemented response mode.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example system architecture, according to an example embodiment of the invention;

FIG. 2 is a diagram illustrating example system architecture, according to an example embodiment of the invention;

FIG. 3 is a flow diagram illustrating techniques according to an example embodiment of the invention; and

FIG. 4 is a diagram illustrating a computing environment in which at least one embodiment of the invention can be implemented.

### DETAILED DESCRIPTION

As described herein, at least one embodiment includes configuring workflows (also referred to herein as conversation flows) in artificial intelligence-based virtual assistants using response modes. As used herein, response modes allow the way that artificial intelligence-based virtual assistants respond to user requests to be governed by at least one customizable set of behaviors and/or configurations. As further detailed herein, a response mode can refer to a named group of settings with values that are interpreted by at least one virtual assistant to alter the virtual assistant's behavior in response to at least one user request. Because behavior characteristics can be captured in a mode definition, the behavior associated with a range of characteristics can be changed at the level of a discrete function, or action of a virtual assistant, without modifying the behavior of other actions of the virtual assistant.

In at least one embodiment, artificial intelligence-based virtual assistants (also referred to herein simply as virtual assistants) comprise software programs which use one or more natural language processing models and/or techniques in conjunction with one or more statistical probability techniques to process and understand human language inputs. For example, such artificial intelligence-based virtual assistants can employ at least one classification algorithm such as support vector machines (SVMs) to detect intents of users and named entity recognition (NER) to identify entities referenced in user requests. Also, virtual assistants can be trained, for example, to understand variations in how users express requests in one or more languages, as well as to classify and map requests to one or more actions (e.g., responses, follow-up questions, etc.).

In one or more embodiments, when a virtual assistant is uncertain and/or does not fully understand what a user is requesting, the virtual assistant can be trained and/or configured to prompt the user to seek further information from the user and/or to confirm that the virtual assistant has accurately understood the request and mapped the request before starting the action. For example, when a user makes a request that the virtual assistant classifies as related to two or more possible actions, the virtual assistant should attempt to clarify which of those actions the user is specifically requesting.

Additionally, in one or more embodiments, instances exist (e.g., after the virtual assistant has been in use for a given period of time and re-trained and/or fine-tuned accordingly) wherein the virtual assistant can operate in a more confident manner (e.g., with increased accuracy and/or certainty in processing and/or responding to user requests). However, balancing such launch/learning and mature/confident aspects of a virtual assistant present challenges such as, for example, processing and/or adapting to new user requests and new actions, which can be specific to the given individual user.

Accordingly, at least one embodiment includes implementing and configuring virtual assistants with multiple response modes (also referred to herein as operational modes) and/or grouping multiple settings into an element akin to a mode that can be applied at an action level. Further, as additionally detailed herein, one or more embodiments include automatically determining virtual assistant operational changes as one or more actions becomes more mature. As used herein, a mature action refers to an action that has been validated by users with evidence that the action meets needs of users. Such an action would be deemed more “mature” than an action that was just created and has not been validated through usage.

As such, and as described herein, at least one embodiment includes configuring conversation flows in virtual assistants using multiple response modes, wherein such response modes can include, for example, at least one learning clarification mode (also referred to herein as at last one clarifying mode) and at least one confident mode. Other modes can include, for example, modes representing increments between a learning clarification mode and a confident mode. In other words, there may be multiple levels of clarification before reaching a confident mode. Another type of mode can be a “silent” mode in which at least one given action will not be used in a response. Such a mode might be needed, for example, when the corresponding virtual assistant should temporarily stop offering an action to the user, or for the purpose of archiving an action that is no longer needed.

In at least one embodiment, one or more different actions can be carried out by virtual assistants in different modes, and the virtual assistant can have several settings configured therein which can control various operational features (e.g., disambiguation techniques, clarification techniques, threshold values, etc.) associated with each of the different modes. In one or more embodiments, initial settings (e.g., default initial settings) for operational features can be determined and/or set based at least in part on user testing, experiments, and analysis of relevant data. Additionally or alternatively, various operational features are initially set by defaults for the general class of virtual assistants.

One or more embodiments can also include modifying one or more of the modes and/or the settings/features thereof based at least in part on the application use case and/or training data distribution. For example, if the training data distribution suggests that an action has not been trained with sufficient quality data, the initial mode should be set to a clarifying mode. Additionally, such an embodiment can include automatically transitioning a virtual assistant from one mode to another mode based at least in part on processing the evolution of the virtual assistant. Processing the evolution of the virtual assistant can include, for example, processing one or more statistics related to virtual assistant operation (e.g., if an action has a poor completion percentage—that in the cases the action starts, it does not lead to a successful outcome—then this action should not operate with a confident response mode but should instead be set to a clarifying response mode because involvement of a human agent may be needed; by contrast, if an action completes successfully for the user at a high rate, that action should be moved to a confident response mode), monitoring and/or processing data distribution-related information (e.g., the ratio of clicks to no-clicks when the action is presented in a clarifying question list), and/or processing information pertaining to user satisfaction. By way of example, user satisfaction can be determined using one or more established mechanisms in the field whereby a user can provide a gesture (e.g., thumbs up or thumbs down) and/or respond to a survey question. In one or more embodiments, higher measures of user satisfaction can lead to setting actions to a more confident mode, and lower measures of user satisfaction can lead to setting actions to a more clarifying mode. Monitoring user satisfaction after making a mode change can help, for example, validate the change in mode.

Additionally, as further detailed herein, at least one embodiment can include determining and implementing at least one change to one or more particular mode settings based at least in part on processing one or more external signals. By way merely of example, a mode setting such as generating and outputting a “connect to support” prompt can be modified such that the prompt is to be generated and output less often upon a determination that related support agents have capacity below a given threshold amount (wherein such a determination can be made by processing capacity-related data pertaining to the support agents). Another example of changing settings based on processing an external signal can include displaying a prompt to automatically process a transaction less often when the servers that process that automated transaction are near full capacity.

One or more embodiments include grouping sets of one or more configuration parameters into distinct operational modes for one or more virtual assistants. Such an embodiment can also include, as further described herein, automatically changing the active operational mode of a given virtual assistant based at least in part on processing of operational data (e.g., an ongoing stream of operational data, which can include usage statistics, data distribution information, user satisfaction rate(s), etc.) pertaining to the given virtual assistant.

In at least one embodiment, one or more modes and/or settings thereof can be related to clarification techniques and disambiguation techniques of the given virtual assistant(s). For example, with respect to single topic clarification, instead of providing an incorrect and/or inaccurate response to a user request, the virtual assistant can carry out a clarification action. For instance, the user can be provided with a choice to investigate options related to the user's request, and the virtual assistant can generate one or more prompts with one or more request-related options including, e.g., the option to communicate with a human support agent. By way of further example, with respect to multi-topic clarification, when a request is ambiguous to the virtual assistant, instead of giving a single answer that may or may not be what the user intended, the virtual assistant can generate and output multiple choices that are similar to and/or related to the request.

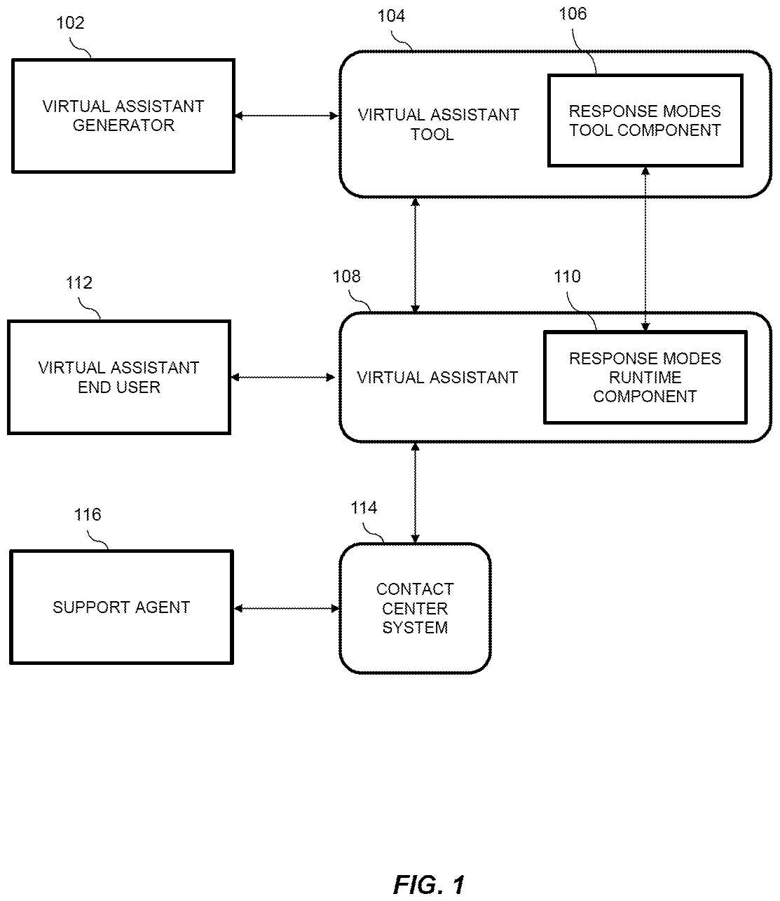

FIG. 1 is a diagram illustrating example system architecture, according to an example embodiment of the invention. By way of illustration, FIG. 1 depicts virtual assistant generator 102, virtual assistant tool 104 (which includes response modes tool component 106), virtual assistant end user 112, virtual assistant 108 (which includes response modes runtime component 110), contact center system 114 and support agent 116. Additionally, virtual assistant generator 102 creates and/or provides training data (e.g., action data, intent data, example phrases for how users would express their intent, etc.) for virtual assistant 108, using virtual assistant tool 104, and specifies at least a portion of content of responses to be provided by the virtual assistant 108 to the virtual assistant end user 112. By way of example, virtual assistant generator 102 can specify and/or provide virtual assistant response content in the form of text and/or rich media including image data, video data, links to additional content, etc. Such specified and/or provided content can be associated with an action or with at least one specific step within an action.

Also, virtual assistant generator 102 defines multiple response modes, using response modes tool component 106. In one or more embodiments, such an action can include, for example, defining a clarifying mode and a confident mode based at least in part on action matches, support options in connection with asking clarification questions, validating attempts before offering support, etc. Further, virtual assistant generator 102 can assign at least a portion of the defined modes to one or more predetermined virtual assistant actions (e.g., assigning a clarifying mode to a bill pay action). Additionally or alternatively, response modes tool component 106 can automatically assign at least a portion of the defined modes to one or more predetermined virtual assistant actions based at least in part on characteristics of the training data. For example, if the training data distribution suggests that an action has not been trained with sufficient quality data, the initial mode can be set to a clarifying mode.

Also, as depicted in FIG. 1, virtual assistant 108 can generate responses to requests from virtual assistant end user 112. Further, in one or more embodiments, virtual assistant 108 maintains awareness of other system elements, including the contact center system 114 (e.g., by processing data related to support agent 116 availability) in order to enact a response mode, using response modes runtime component 110, according to the mode definitions determined by response modes tool component 106. Additionally, response modes runtime component 110 and response modes tool component 106 interact to transition one or more actions from one request mode to another request mode based at least in part on processing runtime usage data, data distribution information, one or more metrics, etc. For example, an artificial intelligence model or algorithm trained with patterns of what constitutes a clarifying mode and/or confident mode can be periodically used to determine the best mode to apply to each of one or more actions. If the model predicts the optimal mode that is different than the current mode for a given action, at least one embodiment can include automatically changing the action's mode setting.

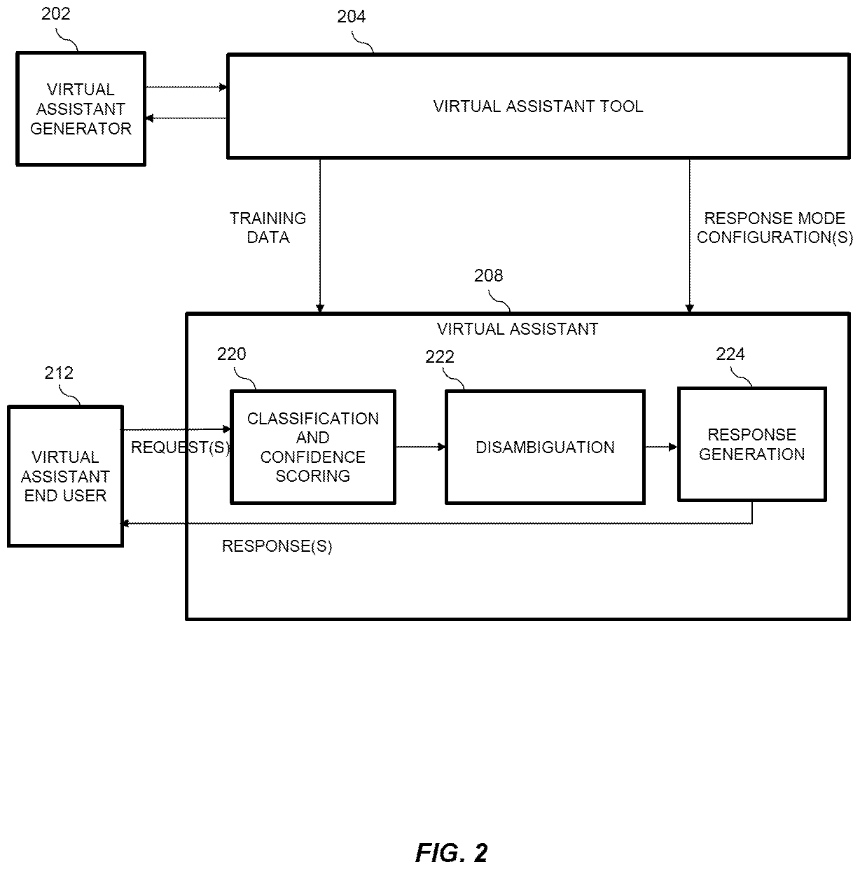

FIG. 2 is a diagram illustrating example system architecture, according to an example embodiment of the invention. By way of illustration, FIG. 2 depicts virtual assistant generator 202, virtual assistant tool 204, virtual assistant 208 and virtual assistant end user 212. More specifically, virtual assistant generator 202, via virtual assistant tool 204, provides training data and response mode configuration(s) to virtual assistant 208. Also, as part of the response mode configuration(s), virtual assistant tool 204 can customize the levels of clarification within the defined modes (e.g., a clarifying mode and a confident mode).

Additionally, virtual assistant end user 212 provides at least one request to the virtual assistant 208. Specifically, the at least one request is processed by virtual assistant 208 across multiple steps. For example, step 220 includes generating at least one classification and confidence score for the at least one request. Also, step 222 includes performing disambiguation in connection with the at least one request. Further, step 224 includes generating at least one response to the at least one request, which can then be forwarded and/or output to the virtual assistant end user 212. Response modes use the output of classification and confidence scoring (via step 220), including an array of possible actions, and apply the behavior defined in the response mode setting for each of the relevant actions. Also, a response may include clarification of a single action, disambiguation among two or more actions (via step 222), and/or a choice for the user to connect to a support agent. The response is then formatted, via step 224, for returning to the virtual assistant end user 212.

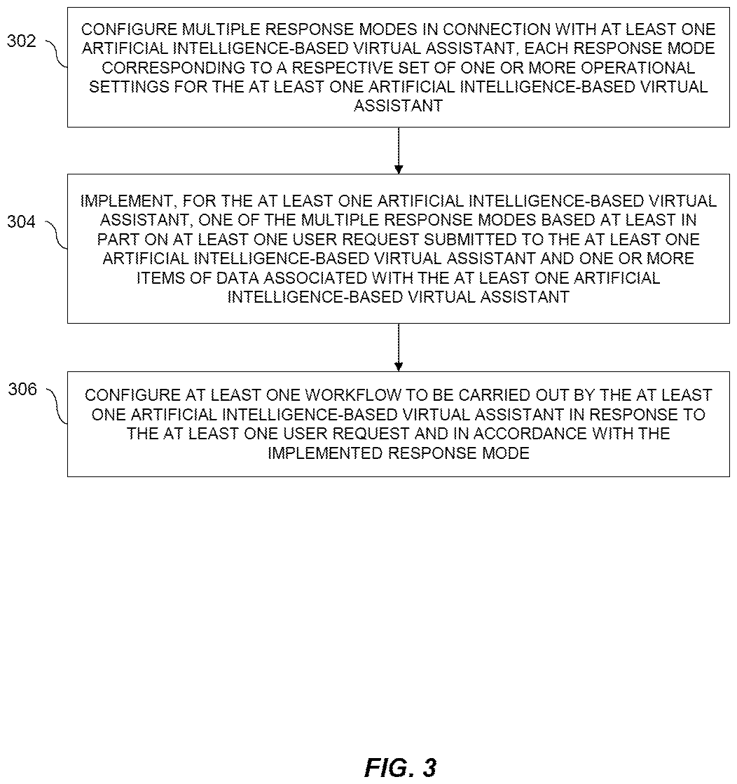

FIG. 3 is a flow diagram illustrating techniques according to an embodiment of the present invention. Step 302 includes configuring multiple response modes in connection with at least one artificial intelligence-based virtual assistant, wherein each of the multiple response modes correspond to a respective set of one or more operational settings for the at least one artificial intelligence-based virtual assistant. In at least one embodiment, the one or more operational settings for the at least one artificial intelligence-based virtual assistant include one or more settings pertaining to disambiguation techniques, one or more settings clarification techniques, and/or one or more threshold values associated with one or more actions. Additionally or alternatively, configuring multiple response modes can include associating at least one action with at least one of the multiple response modes.

In one or more embodiments, configuring multiple response modes in connection with the at least one artificial intelligence-based virtual assistant includes configuring at least one clarification response mode in connection with the at least one artificial intelligence-based virtual assistant. In such an embodiment, configuring at least one clarification response mode includes configuring the at least one artificial intelligence-based virtual assistant to at least one of prompt a user for additional information related to a user request, and confirm that the at least one artificial intelligence-based virtual assistant has understood the request.

Additionally or alternatively, in at least one embodiment, configuring multiple response modes in connection with the at least one artificial intelligence-based virtual assistant includes configuring at least one confident response mode in connection with the at least one artificial intelligence-based virtual assistant. In such an embodiment, configuring at least one confident response mode includes configuring the at least one artificial intelligence-based virtual assistant to generate one or more responses to one or more user requests without seeking additional input from the user.

Step 304 includes implementing, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant. In one or more embodiments, the one or more items of data associated with the at least one artificial intelligence-based virtual assistant include one or more items of data related to usage statistics of the at least one artificial intelligence-based virtual assistant, one or more items of data related to data distribution associated with the at least one artificial intelligence-based virtual assistant, and/or one or more items of data related to user satisfaction with performance of the at least one artificial intelligence-based virtual assistant.

Step 306 includes configuring at least one workflow to be carried out by the at least one artificial intelligence-based virtual assistant in response to the at least one user request and in accordance with the implemented response mode. In at least one embodiment, configuring at least one workflow includes determining a sequence of two or more actions to be performed by the at least one artificial intelligence-based virtual assistant. Further, one or more embodiments can also include automatically initiating execution of the sequence of two or more actions by the at least one artificial intelligence-based virtual assistant.

In one or more embodiments, the techniques depicted in FIG. 3 can also include performing one or more automated actions based at least in part on the configuring of the at least one workflow. In such an embodiment, performing one or more automated actions can include automatically training at least a portion of the at least one artificial intelligence-based virtual assistant based at least in part on feedback related to the configuring of the at least one workflow, and/or automatically modifying one or more of the multiple response modes based at least in part on feedback related to the configuring of the at least one workflow.

Additionally or alternatively, the techniques depicted in FIG. 3 can also include automatically modifying one or more of the multiple response modes based at least in part on processing one or more external signals related to the at least one artificial intelligence-based virtual assistant. In such an embodiment, automatically modifying one or more of the multiple response modes based at least in part on processing one or more external signals can include automatically modifying one or more of the multiple response modes based at least in part on processing one or more external signals pertaining to support agent capacity available to supplement operations of the at least one artificial intelligence-based virtual assistant.

Further, in one or more embodiments, software implementing the techniques depicted in FIG. 3 can be provided as a service in a cloud environment.

As detailed herein, at least one embodiment may provide a beneficial effect such as, for example, enhancing accuracy of artificial intelligence-based virtual assistants, as well as improving user experience and/or adoption in connection with such virtual assistants.

It is to be appreciated that some embodiments described herein utilize one or more artificial intelligence models. It is to be appreciated that the term “model,” as used herein, is intended to be broadly construed and may comprise a set of executable instructions for generating computer-implemented recommendations and/or predictions. For example, one or more of the models described herein (e.g., one or more artificial intelligence models associated with at least one virtual assistant) may be trained to generate responses to user requests based at least in part on one or more response modes configured as part of at least one corresponding virtual assistant (e.g., corresponding to virtual assistant 108 and/or 208), and such responses can be used to initiate one or more automated actions (e.g., automatically retraining at least a portion of the one or more models, engaging at least one support agent, etc.).

The techniques depicted in FIG. 3 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 3 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code 426 involved in performing the inventive methods, such as configuring virtual assistant response modes. In addition to code 426, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and code 426, as identified above), peripheral device set 414 (including user interface (UI) device set 423, storage 424, and Internet of Things (IOT) sensor set 425), and network module 415. Remote server 404 includes remote database 430. Public cloud 405 includes gateway 440, cloud orchestration module 441, host physical machine set 442, virtual machine set 443, and container set 444.

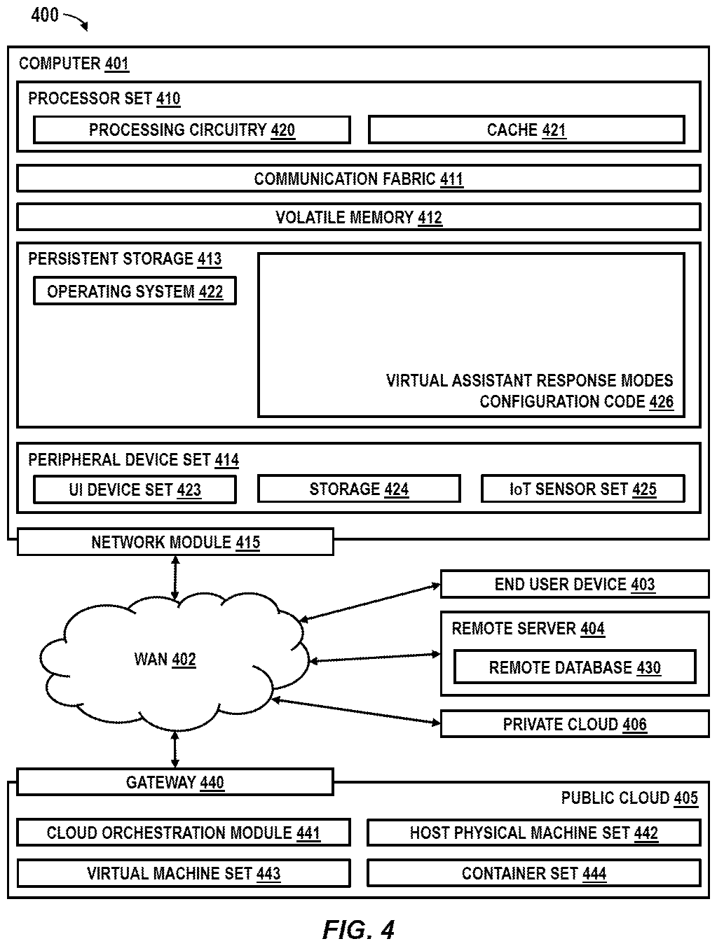

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

Processor set 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code 426 in persistent storage 413.

Communication fabric 411 is the signal conduction path that allows the various components of computer 401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 412 is any type of volatile memory now known or to be developed in the future. Examples include dynamic type RAM or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

Persistent storage 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a ROM, but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in code 426 typically includes at least some of the computer code involved in performing the inventive methods.

Peripheral device set 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

Network module 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

In computing environment 400, computer 401 is shown as being connected to the internet (see WAN 402). However, in many embodiments of the present invention computer 401 will be isolated from communicating over communications network and not connected to the internet, running as a standalone computer. In these embodiments, network module 415 of computer 401 may not be necessary or even desirable in order to ensure isolation and to prevent external communications coming into computer 401. The standalone computer embodiments can be potentially advantageous, at least in some applications of the present invention, because they are typically more secure. In other embodiments, computer 401 is connected to a secure WAN or a secure LAN instead of WAN 402 and/or the internet. In these network connected (that is, not standalone) embodiments, the system designer may want to take appropriate security measures, now known or developed in the future, to reduce the risk that incoming network communications do not cause a security breach.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory configured to store program instructions; and
a processor operatively coupled to the memory to execute the program instructions to:
configure multiple response modes in connection with at least one artificial intelligence-based virtual assistant, wherein each of the multiple response modes correspond to a respective set of one or more operational settings for the at least one artificial intelligence-based virtual assistant;
implement, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant; and
configure at least one workflow to be carried out by the at least one artificial intelligence-based virtual assistant in response to the at least one user request and in accordance with the implemented response mode.

2. The system of claim 1, wherein the processor is further operatively coupled to the memory to execute the program instructions to:
perform one or more automated actions based at least in part on the configuring of the at least one workflow.

3. The system of claim 2, wherein performing one or more automated actions comprises at least one of automatically training at least a portion of the at least one artificial intelligence-based virtual assistant based at least in part on feedback related to the configuring of the at least one workflow, and automatically modifying one or more of the multiple response modes based at least in part on feedback related to the configuring of the at least one workflow.

4. The system of claim 1, wherein the processor is further operatively coupled to the memory to execute the program instructions to:
automatically modify one or more of the multiple response modes based at least in part on processing one or more external signals related to the at least one artificial intelligence-based virtual assistant.

5. The system of claim 4, wherein automatically modifying one or more of the multiple response modes based at least in part on processing one or more external signals comprises automatically modifying one or more of the multiple response modes based at least in part on processing one or more external signals pertaining to support agent capacity available to supplement operations of the at least one artificial intelligence-based virtual assistant.

6. The system of claim 1, wherein the one or more operational settings for the at least one artificial intelligence-based virtual assistant comprise at least one of one or more settings pertaining to disambiguation techniques, one or more settings clarification techniques, and one or more threshold values associated with one or more actions.

7. The system of claim 1, wherein configuring at least one workflow comprises determining a sequence of two or more actions to be performed by the at least one artificial intelligence-based virtual assistant.

8. The system of claim 1, wherein the one or more items of data associated with the at least one artificial intelligence-based virtual assistant comprise at least one of one or more items of data related to usage statistics of the at least one artificial intelligence-based virtual assistant, one or more items of data related to data distribution associated with the at least one artificial intelligence-based virtual assistant, and one or more items of data related to user satisfaction with performance of the at least one artificial intelligence-based virtual assistant.

9. The system of claim 1, wherein configuring multiple response modes in connection with the at least one artificial intelligence-based virtual assistant comprises configuring at least one clarification response mode in connection with the at least one artificial intelligence-based virtual assistant.

10. The system of claim 9, wherein configuring at least one clarification response mode comprises configuring the at least one artificial intelligence-based virtual assistant to at least one of prompt a user for additional information related to a user request, and confirm that the at least one artificial intelligence-based virtual assistant has understood the user request.

11. The system of claim 1, wherein configuring multiple response modes in connection with the at least one artificial intelligence-based virtual assistant comprises configuring at least one confident response mode in connection with the at least one artificial intelligence-based virtual assistant.

12. The system of claim 11, wherein configuring at least one confident response mode comprises configuring the at least one artificial intelligence-based virtual assistant to generate one or more responses to one or more user requests without seeking additional input from the user.

13. The system of claim 1, wherein configuring multiple response modes comprises associating at least one action with at least one of the multiple response modes.

14. A computer program product comprising a computer readable storage medium having program instructions embodied therewith, the program instructions executable by a computing device to cause the computing device to:
configure multiple response modes in connection with at least one artificial intelligence-based virtual assistant, wherein each of the multiple response modes correspond to a respective set of one or more operational settings for the at least one artificial intelligence-based virtual assistant;
implement, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant; and
configure at least one workflow to be carried out by the at least one artificial intelligence-based virtual assistant in response to the at least one user request and in accordance with the implemented response mode.

15. The computer program product of claim 14, wherein the program instructions executable by a computing device further cause the computing device to:
perform one or more automated actions based at least in part on the configuring of the at least one workflow.

16. The computer program product of claim 14, wherein the one or more operational settings for the at least one artificial intelligence-based virtual assistant comprise at least one of one or more settings pertaining to disambiguation techniques, one or more settings clarification techniques, and one or more threshold values associated with one or more actions.

17. A computer-implemented method comprising:
configuring multiple response modes in connection with at least one artificial intelligence-based virtual assistant, wherein each of the multiple response modes correspond to a respective set of one or more operational settings for the at least one artificial intelligence-based virtual assistant;
implementing, for the at least one artificial intelligence-based virtual assistant, one of the multiple response modes based at least in part on at least one user request submitted to the at least one artificial intelligence-based virtual assistant and one or more items of data associated with the at least one artificial intelligence-based virtual assistant; and
configuring at least one workflow to be carried out by the at least one artificial intelligence-based virtual assistant in response to the at least one user request and in accordance with the implemented response mode;
wherein the method is carried out by at least one computing device.

18. The computer-implemented method of claim 17, comprising:
performing one or more automated actions based at least in part on the configuring of the at least one workflow.

19. The computer-implemented method of claim 17, wherein the one or more operational settings for the at least one artificial intelligence-based virtual assistant comprise at least one of one or more settings pertaining to disambiguation techniques, one or more settings clarification techniques, and one or more threshold values associated with one or more actions.

20. The computer-implemented method of claim 17, wherein configuring at least one workflow comprises determining a sequence of two or more actions to be performed by the at least one artificial intelligence-based virtual assistant.
